(19) United States
(12) Patent Application Publication
(10) Pub. No.: US 2002/0052964 A1
(43) Pub. Date: May 2, 2002

(54) Method and device for data communication

(76) Inventors: Carl Johan Ferner, Stockholm (SE); Jasper Hansson, Linkoping (SE)

Correspondence Address: NIXON & VANDERHYE P.C., 8th Floor, 1100 North Glebe Road, Arlington, VA, 22201, US

(21) Appl. No.: 09/911,085

(22) Filed: Jul. 24, 2001

(30) Foreign Application Priority Data
Jul. 28, 2000 (SE) 0002790-4

(51) Int. Cl. G06F 15/16

(52) U.S. Cl. 709/230

(57) ABSTRACT

A method and a system for initiating a connection between a first computer (19) connected to an IP network (13) and at least one second computer (3) connected to a network (1) where the location is indicated by another number than an IP-address, the two networks being connected through at least one access router (9,11;63).

According to the invention the method comprises the steps:

receiving in a device (21;63) in the IP network from the first computer (19) a request of being connected to the at least one second computer (3);

identifying, in the device (21;61) a number corresponding to the IP-address of each second computer (3);

sending information about this at least one corresponding number to one of the access routers (11;63);

receiving this information in the access router (11;63), which sets up a line from the first computer (19) to each second computer (3);

### BACKGROUND OF THE INVENTION

The present invention relates to a method for initiating a connection between a first computer connected to an IP-network and at least one second computer connected to a network where the location is indicated by another number than an IP-address, the two networks being connected through at least one access router.

It also relates to a device for identifying a number to an IP-address.

It relates as well to an access router adapted for connecting an IP-network and a network where the location is described with another number than an IP-address to each other.

It relates also to a network comprising interconnected subnetworks with different address number systems.

### RELATED ART

When a connection needs to be initiated from a first computer connected to an IP network to a second computer connected to a telephone network, the first computer sends a request for being connected to the second computer to an access router connecting the two networks. This request comprises the IP address of the second computer. The IP address has to be translated to the corresponding telephone number that the second computer is connected to in the telephone network to enable the connection. In related art it is common that this translation, or matching between addresses, is performed in one or more access routers provided between the two networks.

One problem with this prior method is that the access routers only can handle a limited number of addresses. The access routers have a list of IP-addresses and the corresponding telephone numbers but this list is limited in length. Many connections initiated from an IP network to a telephone network are for example needed when many service gateways, connected to a telephone network, should be remotely handled. Service gateways are provided in homes for controlling and monitoring different home electronics, such as for example the temperature, the sauna, the washing machine etc. The service gateways can be remotely controlled, for example from a computer connected to an IP-network.

### SUMMARY

The object of the present invention is to provide an effective method to initiate connections from an IP-network to for example a telephone network.

This is achieved by a method of the initially defined kind, comprising the steps of:

receiving in a device in the IP network from the first computer a request of being connected to the at least one second computer;

identifying, in the device a number corresponding to the IP-address of each second computer;

providing information about this at least one corresponding number to one of the access routers;

receiving this information in the access router, which sets up a line from the first computer to each second computer;

connecting the first computer with the at least one second computer.

It is also achieved by a device of the initially defined kind, said device being connectable to at least one access router and it comprises device receiving means for receiving a request for address information, retrieving means, connected to the device receiving means, for forwarding this request to an address data base and for receiving the answer from the address data base and information means, connected to the retrieving means for informing the access router about this number correspondence.

Furthermore it is achieved by an access router of the initially defined kind, said access router comprising information receiving means adapted for receiving information from the device about the IP-address and number correspondence and/or which line out from the access router that should be used for a connection.

Further it is achieved by a network of the initially defined kind, said network comprising such a device and such an access router.

In this way the matching of IP-addresses and numbers is done in a device comprised in the IP-network and connected to the access routers. Thus the limited size of the access routers does not affect the number of possible connections initiated from the IP-network to the other network.

Preferably an address data base connected to the device is used to match the IP-address to a number.

In one embodiment of the invention the IP-address is identified with a telephone number. Hereby connections could be initiated from an IP-network to a telephone network.

A request from the first computer for a connection to the at least one second computer is preferably received in the device, said device being connected to the IP-network and to the access routers.

Then a free line data base, comprising information about which lines from the access routers that are free at the moment, could be used to choose a line for the connection. The retrieving means is thus adapted to send a question to the free line data base about which lines that are free to use for the moment and also receive an answer from the free line data base. The information means are in this case also adapted to inform the access router about which line that should be used for the connection. In this case the device is adapted to be placed in the IP-network and to be in contact with more than one access router.

Alternatively the request from the first computer for a connection to the at least one second computer is received in an access router, a question about the IP-address and number correspondence is sent from the access router to the device and an answer is received in the access router from the device. In this case the device is adapted to be placed in, or in direct connection to, each access router. The access router comprises preferably sending means from which a request is sent to the device about the IP-address and number correspondence and/or which line out from the access router that should be used for the connection.

### BRIEF DESCRIPTION OF THE DRAWINGS

FIG. 1 a shows a schematic view of a system of two networks comprising a device according to a first embodiment of the invention.

FIG. 1b shows a flow chart of the method according to the first embodiment of the invention.

FIG. 2a shows a schematic view of a system of two networks comprising a device according to a second embodiment of the invention.

FIG. 2b shows a flow chart of the method according to the second embodiment of the invention.

### DETAILED DESCRIPTION OF EMBODIMENTS

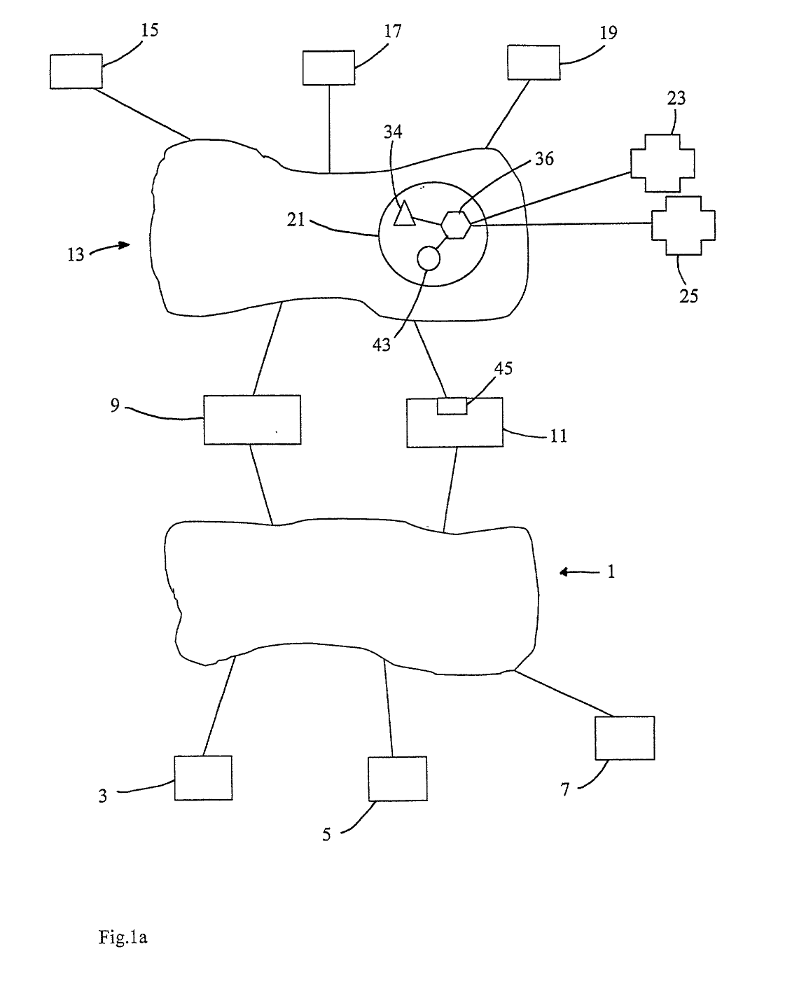

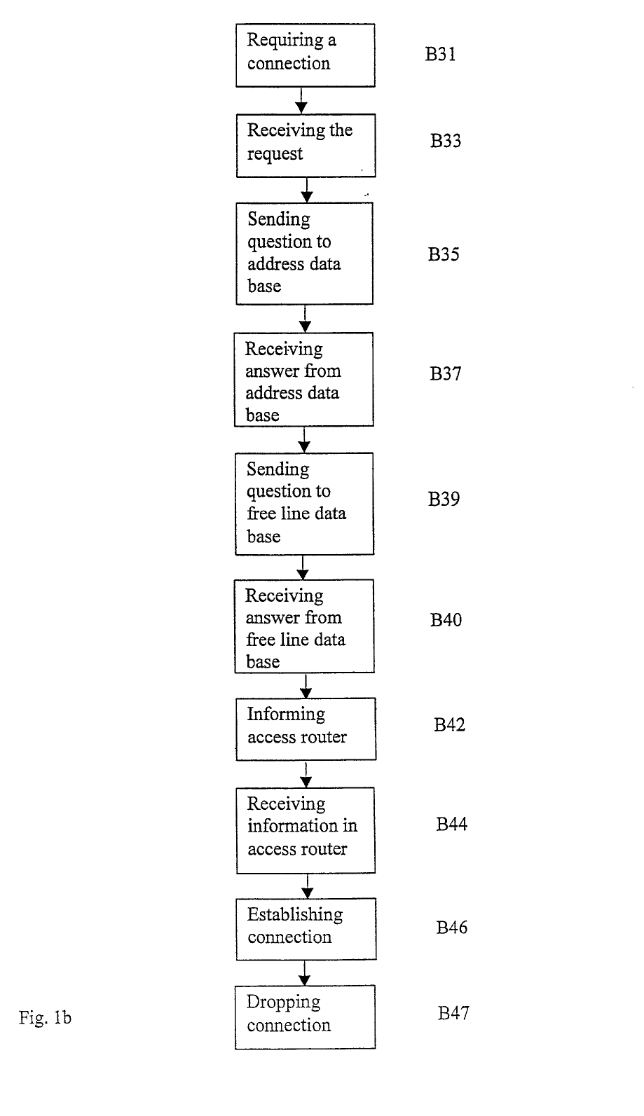

FIG. 1a shows a schematic view of a system of networks and computers comprising a first embodiment of a device 21 according to the invention. In this figure a telephone network 1 connected to three computers 3,5,7 is shown. Normally of course more than three computers will be connected. The telephone network 1 is also connected through two access routers 9,11 to an IP-network 13. The IP-network 13 in turn is connected to three IP-network connected computers 15,17,19. The number of access routers and computers is only intended as an example.

In this embodiment a device 21 according to the invention is located in the IP-network 13. This device 21 is used every time one of the computers 15,17,19 connected to the IP-network wants to set up a connection to one or more of the computers 3,5,7 connected to the telephone network 1. The function of the device 21 is to identify the connection, i.e. match the IP-number of the computer connected to the telephone network with the telephone number that this computer is connected to, and to allocate to each connection a free line, i.e. a line that is not occupied for a connection at the moment, from one of the access routers 9,11. The device 21 thus has access to, in this embodiment, an address data base 23 and a free line data base 25. The address data base 23 comprises information about which IP-number corresponds to which telephone number. The free line data base 25 comprises information about the lines out from the access routers 9,11 that are available at the moment. With this information the device 21 is able to both match the IP-number and telephone number for the requested connection, choose one of the access routers 9,11 for the connection and choose an available line from the decided access router to the requested computer connected to the telephone network 1. If more than one computer connected to the telephone network is requested to be connected to the computer connected to the IP-network the device 21 chooses one line for each of the connections.

The above described telephone network could also comprise a mobile telephone network. The invention is also applicable in a system of networks as described above where the telephone network is replaced by another kind of network in which the locations are indicated by some other numbers than IP-addresses.

In FIG. 1b a flow chart over the connection process according to the first embodiment of the invention is shown. The units participating in the process are shown in FIG. 1a. The process starts with block B31 where a connection with one of the computers 3 connected to the telephone network, here called the second computer, is required from one of the computers 19 connected to the IP-network 13, here called the first computer. In block B33 the device 21 receives this request in a device receiving means 34. In block B35 the device 21 uses a retrieving means 36, connected to the receiving means 34, to send a question to the address data base 23 about which telephone number that corresponds to the asked IP-number. The address data base 23 identifies the telephone number corresponding to the IP-number of the requested computer 3. In block B37 the answer from the address data base 23 is received in the retrieving means 36 in the device 21. Then, in block B39, the device 21 sends, from the retrieving means 36, a question to the free line data base 25 about which line that is free and can be used for this asked connection. The free line data base 25 comprises information of available lines from the access routers. In block B40 the answer from the free line data base 25 is received in the retrieving means 36. If no free line is available at the moment a message is sent back to the initiator telling that the connection not is possible for the moment.

In block B42 the device 21 informs, from information means 43, connected to the retrieving means 36, the decided access router, e.g. 11, about which line that should be used for the connection and to which telephone number the line should connect. In block B44 this information is received in the access router 11 in information receiving means 45. Each access router of course comprises such an information receiving means 45 even though only one is shown in FIG. 1a. After that, in block B46, a line is set up and a connection is established between the first computer 19 and the second computer 3. In block B47 the call is terminated and the connection is dropped. The line could now be used for another connection.

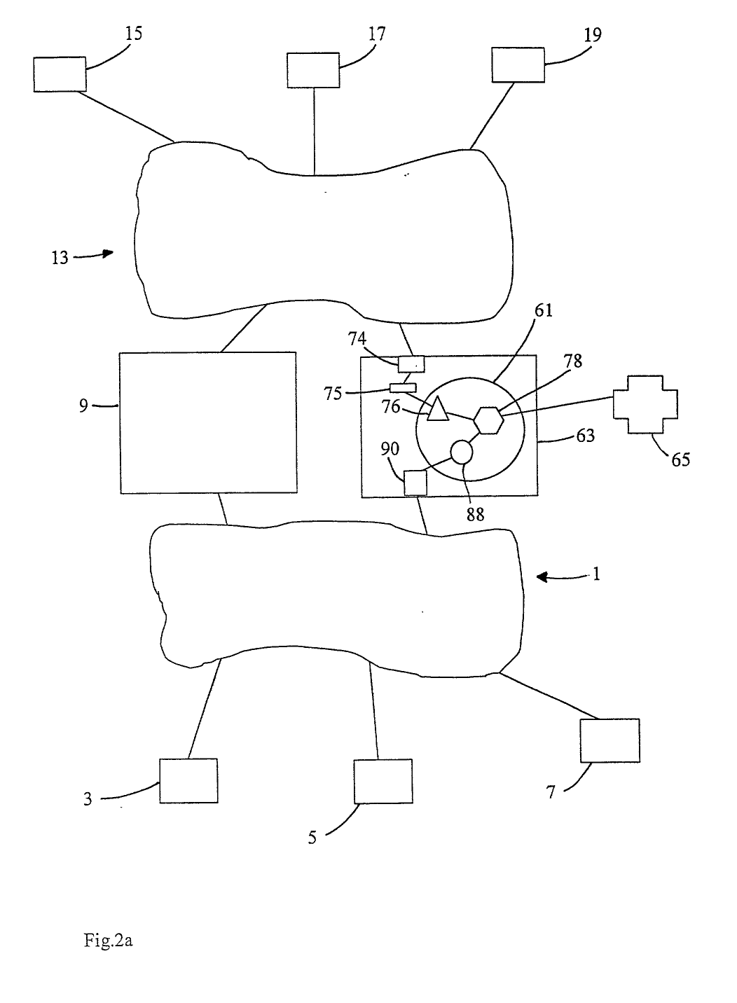

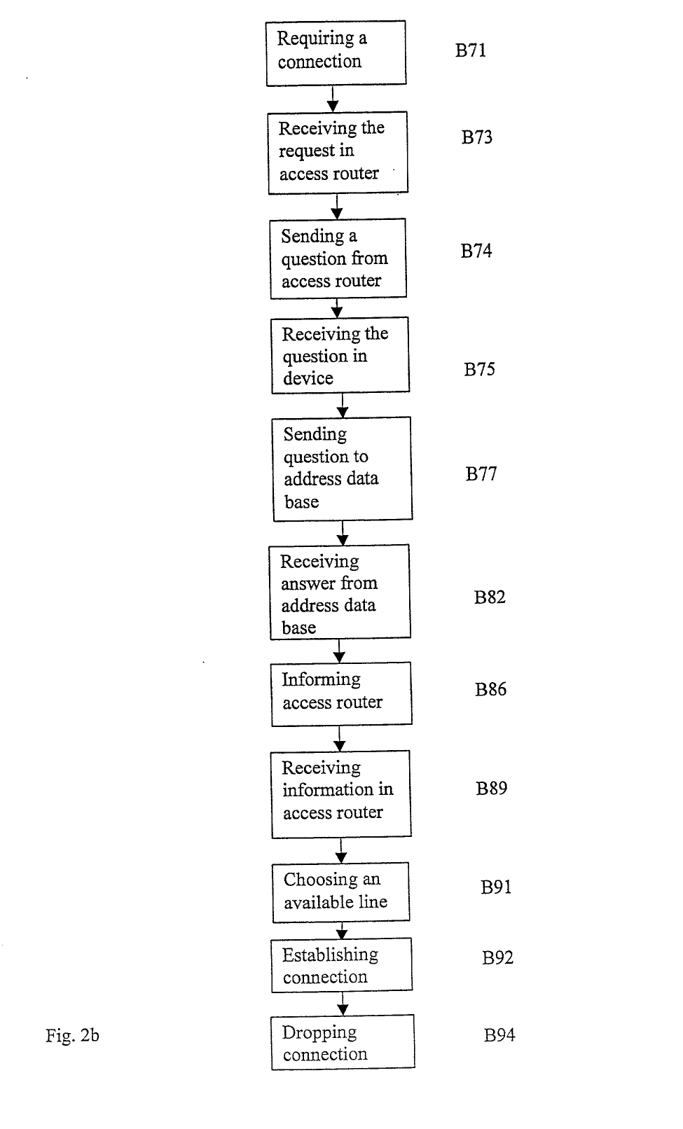

FIG. 2a shows a second embodiment of the invention. In this embodiment a device 61 according to the invention is placed in, or in direct connection to, an access router 63. This means that there must be one device for each access router but for simplicity only one is shown in this figure. The other parts of the figure, i.e. the telephone network, the IP-network and the computers are the same as in the first embodiment and are also given the same reference numbers. The difference from the first embodiment is that this device 61 is not able to choose between different access routers. The device 61 is in this embodiment connected to only one data base 65 comprising information about IP-numbers and telephone numbers equivalents. It is, however, possible in this embodiment as well to connect the device to a free line data base. The device 61 provides the access router 63 with information about the address and telephone number correspondence and the access router 63 can then choose a free line for the connection. When the call is ended due to for example so called idle timeout the connection is dropped and the line could be used for another connection. Idle timeout is a function that forces a connection to be disconnected when the connection has not been used for a certain time period.

In FIG. 2b a flow chart of the connection process according to the second embodiment of the invention is shown. The units participating in the process are shown in FIG. 2a. In block B71 a connection with one of the computers 3 connected to the telephone network 1, here called the second computer, is required from one of the computers 19 connected to the IP-network 13, here called the first computer. In block B73 the access router 63 receives this request in a receiving means 74. Then in block B74 the access router 63 sends, from sending means 75 connected to the receiving means 74, a request of which telephone number that corresponds to the IP-number of the requested second computer 3. In block B75, the device 61 receives this request in a device receiving means 76. In block B77 the device 61 forwards this request, from a retrieving means 78, connected to the device receiving means 76, to the address data base 65. The matching of addresses is performed in the address data base 65 and in block B82 the answer to the request is sent from the data base 65 and received in the retrieving means 78 in the device 61.

In block B86 the device 61 sends, from an information means 88, connected to the retrieving means 78, the requested telephone number to the access router 63. In block B89, the access router 63 receives this information, in an information receiving means 90. Then, in block B91, the access router 63 chooses one of the available lines out for the connection. In block B92 a line is set up and the connection is established between the IP-network connected computer 19 and the telephone network connected computer 3. In block B94 the IP-network connected computer 19 ends the connection and the line is free to use for another connection.

1. A method for initiating a connection between a first computer (19) connected to an IP network (13) and at least one second computer (3) connected to a network (1) where the location is indicated by another number than an IP-address, the two networks being connected through at least one access router (9,11;63), the method comprising the steps of:
receiving in a device (21;61) in the IP network from the first computer (19) a request of being connected to the at least one second computer (3);
identifying, in the device (21;61) a number corresponding to the IP-address of each second computer (3);
providing information about this at least one corresponding number to one of the access routers (11;63);
receiving this information in the access router (11;63), which sets up a line from the first computer (19) to each second computer (3);
connecting the first computer (19) with the at least one second computer (3).

2. A method according to claim 1, characterised by using an address data base (23; 65) connected to the device (21;61) to match the IP-address to a number.

3. A method according to claim 1 or 2, characterised by identifying the IP-address with a telephone number.

4. A method according to any one of the preceding claims, characterised by receiving in the device (21) a request from the first computer (19) for a connection to the at least one second computer (3), said device (21) being connected to the IP-network (13) and to the access routers (9,11).

5. A method according to any one of the preceding claims, characterised by using a free line data base (25), comprising information about which lines from the access routers (9,11) that are free at the moment, to choose a line for the connection.

6. A method according to any one of the claims 1-3, characterised by receiving in an access router (63) the request from the first computer (19) for a connection to the at least one second computer (3), sending a question about the IP-address and number correspondence from the access router (63) to the device (61) and receiving an answer in the access router (63) from the device (61).

7. A device for identifying a number to an IP-address, characterised in that the device (21 ;6 1) is connectable to at least one access router (9,11 ;63) and in that it comprises device receiving means (34;76) for receiving a request for address information, retrieving means (36;78), connected to the device receiving means (34;76), for forwarding this request to an address data base (23;65) and for receiving the answer from the address data base (23;65) and information means (43;88), connected to the retrieving means (36;78), for informing the access router (9,11;63) about this number correspondence.

8. A device according to claim 7, characterised in that it is connectable to a free line data base (25) and in that the retrieving means (36) is adapted to also send a question to the free line data base (25) about which lines that are free to use for the moment and in that the retrieving means (36) also is adapted to receive an answer from the free line data base (25) and in that the informing means (43) is also adapted to inform the access router (9,11;63) about which line that should be used for the connection.

9. A device according to claim 7 or 8, characterised in that it is adapted to be placed in the IP-network (13) and to be in contact with more than one access router (9,11).

10. A device according to claim 7 or 8, characterised in that it is adapted to be placed in, or in direct connection to, each access router (9,63).

11. An access router adapted for connecting an IP-network (13) and a network (1) where the location is indicated by another number than an IP-address to each other, characterised in that it comprises information receiving means (45;90) adapted for receiving information from a device (21;61) about the IP-address and number correspondence and/or which line out from the access router (9,11;63) that should be used for a connection.

12. An access router according to claim 11, characterised in that it comprises sending means (75) from which a request is sent to the device (61) about the IP-address and number correspondence and/or which line out from the access router (63) that should be used for the connection.

13. An access router according to claim 11 or 12, characterised in that it comprises a device (61) according to claim 7 or 8.

14. A network comprising interconnected subnetworks with different address number systems, characterised in that it comprises a device according to any one of the claims 7-10 and an access router according to any one of the claims 11-13.
